(19) United States
(12) Patent Application Publication
(10) Pub. No.: US 2014/0130377 A1
(43) Pub. Date: May 15, 2014

(54) SURFACE-MODIFIED PLASTIC SHEET AND ARTICLE COMPRISING THE SAME

(71) Applicant: Sakurai Sports Mfg. Co., Ltd., Kaohsiung City (TW)

(72) Inventor: Hung-Hui Wu, Kaohsiung City (TW)

(21) Appl. No.: 13/933,673

(22) Filed: Jul. 2, 2013

(30) Foreign Application Priority Data
Nov. 12, 2012 (TW) 101142020
Apr. 24, 2013 (TW) 102114596

(51) Int. Cl. C09D 133/20; C09D 7/12

(52) U.S. Cl. CPC C09D 133/20; C09D 7/1233
USPC 36/87; 428/480; 428/521; 428/483; 428/516; 428/336; 428/201

(57) ABSTRACT

A surface-modified plastic sheet includes: a polymer substrate having a plasma treated surface; and a transparent surface-modifying polymer film coated on the plasma treated surface. The surface-modifying polymer film is made from a modified CTBN composition or a clear lacquer composition. The clear lacquer composition contains linear polyester polyol. The modified CTBN composition contains a modified CTBN that is represented by formula (I)

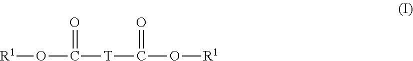

in which T is a butadiene-acrylonitrile copolymer and R¹ is represented by formula (II)

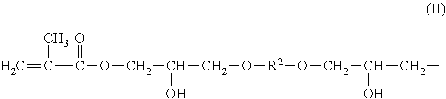

in which R² is a divalent hydrocarbyl group that contains at least one benzene ring.

### CROSS-REFERENCE TO RELATED APPLICATION

This application claims priority of Taiwanese application no. 101142020, filed on Nov. 12, 2012, and Taiwanese application no. 102114596, filed on Apr. 24, 2013.

### BACKGROUND OF THE INVENTION

1. Field of the Invention

This invention relates to a surface-modified plastic sheet and an article comprising the same, more particularly to a surface-modified plastic sheet including a polymer substrate of a substantially non-polar plastic material and a surface-modifying polymer film coated on the polymer substrate.

2. Description of the Related Art

Ultra high molecular weight polyethylene (UHMWPE) is a non-polar plastic material and exhibits properties, such as waterproof, light weight, high resistance to chemical corrosion, high impact strength, high abrasion resistance, and high resistance to embrittlement under extreme weather conditions (−110° C. to 120° C.). However, UHMWPE has a surface morphology that is similar to that of Teflon® and that exhibits a strong hydrophobicity and an extremely low adhesion property, i.e., very difficult to print an ink thereon and to adhesively bond with another material. As a consequence, applications of the UHMWPE are limited.

U.S. Pat. No. 6,057,414 discloses a method of increasing wetting and printing properties of a polymer material, such as UHMWPE. The polymer material is subjected to an ignited plasma under a vacuum for increasing the bonding, wetting, and printing properties of the polymer material. After the plasma treatment, the surface bonding energy of the polymer material is increased, and an adhesive can be bonded to the polymer material for subsequent bonding of the polymer material with another material or an article. Examples of the aforesaid adhesive include silicone-based, acrylic-based, and rubber-based adhesives. Although the surface bonding energy of the polymer material is considerably increased after plasma treatment, the surface bonding energy of the polymer material can be gradually diminished by exposing to the atmosphere. In addition, it normally takes at least one or two days for the adhesive applied to the polymer material to be completely dried, which results in inconvenience in management, storage and handling of the polymer material.

U.S. Pat. No. 5,702,772 discloses a process of manufacturing a painted plastic article for footwear. The method includes the steps of activating a surface of a polymer substrate by plasma treatment so as to increase a surface free energy of the polymer substrate, applying a coating on the activated surface of the polymer substrate, drying the coating to form a temporary protective film on the activated surface so as to render the polymer substrate less susceptible to abrasion or disruption during handling and transporting, removing the temporary protective film from the polymer substrate, and painting the activated surface of the polymer substrate. The surface free energy of the activated surface of the polymer substrate can be preserved by using the temporary protective film. However, since the temporary protective film is made from a water soluble material, the same is required to be removed from the polymer substrate before the activated surface can be painted.

### SUMMARY OF THE INVENTION

Therefore, an object of the present invention is to provide a surface-modified plastic sheet that can overcome the aforesaid drawbacks associated with the prior art.

According to this invention, there is provided a surface-modified plastic sheet that comprises: a transparent polymer substrate made from a substantially non-polar plastic material and having a plasma treated surface; and a transparent surface-modifying polymer film coated on the plasma treated surface of the polymer substrate. The surface-modifying polymer film is made from a modified carboxy-terminated butadiene-acrylonitrile (CTBN) composition or a clear lacquer composition. The clear lacquer composition contains linear polyester polyol. The modified CTBN composition contains a modified CTBN that is represented by formula (I)

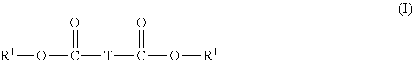

in which T is a butadiene-acrylonitrile copolymer and R¹ is represented by formula (II)

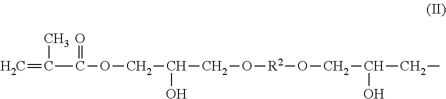

in which R² is a divalent hydrocarbyl group that contains at least one benzene ring.

### BRIEF DESCRIPTION OF THE DRAWINGS

In drawings which illustrate embodiments of the invention,

FIG. 1 is a schematic sectional view of the first preferred embodiment of a surface-modified plastic sheet according to the present invention;

FIG. 2 is a schematic sectional view of the second preferred embodiment of a surface-modified plastic sheet according to the present invention;

FIG. 3 is a perspective view of the preferred embodiment of an article (toecap) for footwear, which contains the first preferred embodiment of the surface-modified plastic sheet; and

FIG. 4 is a schematic sectional view taken along line IV-IV of FIG. 3.

### DETAILED DESCRIPTION OF THE PREFERRED EMBODIMENTS

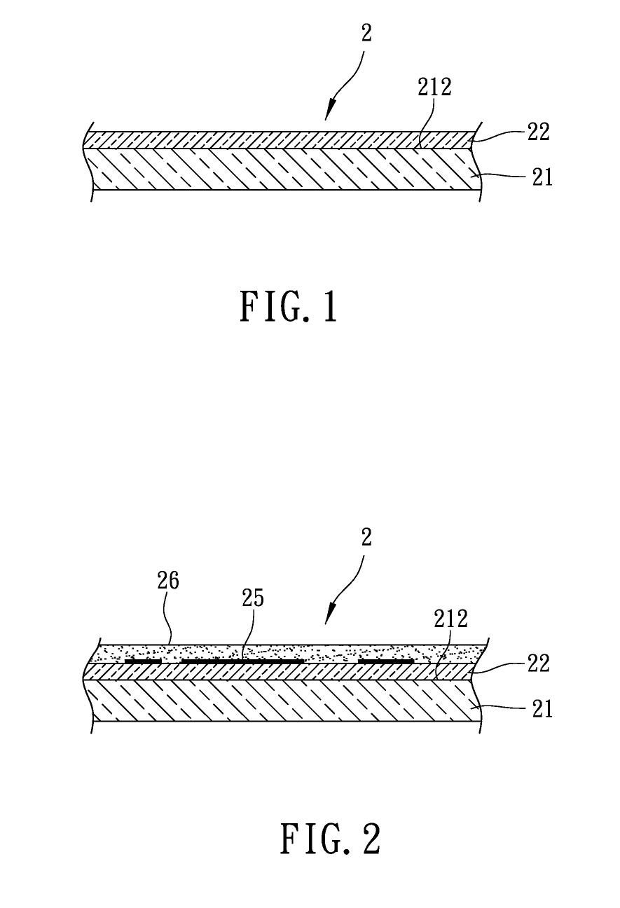

FIG. 1 illustrates the first preferred embodiment of a flexible transparent surface-modified plastic sheet 2 for forming a skin layer or a protective layer of a product, such as snow boots, ice skate boots, pipes, tanks, electronic housings, and panels, according to the present invention.

The surface-modified plastic sheet 2 includes: a transparent polymer substrate 21 made from a substantially non-polar plastic material and having a plasma treated surface 212; and a transparent surface-modifying polymer film 22 coated on the plasma treated surface 212 of the polymer substrate 21. Optionally, a releasing paper (not shown) can be attached to the transparent surface-modifying polymer film 22. The surface-modifying polymer film 22 is made from a modified CTBN composition or a clear lacquer composition.

The clear lacquer composition contains a first organic solvent and linear polyester polyol that is soluble in the first organic solvent. Preferably, the linear polyester polyol is poly(1,4-butylene adipate). Examples of the first organic solvent include cycloalkanones, such as cyclopentanone and cyclohexanone.

The modified CTBN composition contains a second organic solvent and a modified CTBN that is soluble in the second organic solvent and that is represented by formula (I)

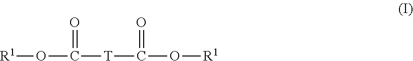

in which T is a butadiene-acrylonitrile copolymer and R¹ is represented by formula (II)

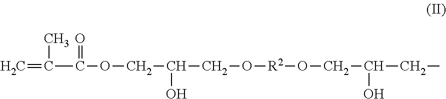

in which R² is a divalent hydrocarbyl group that contains at least one benzene ring. Preferably, R² is represented by formula (III)

—Ar—R³—Ar— (III)

in which R³ is an alkylene group that has 1 to 4 carbon atoms and Ar is a divalent aromatic group having at least one benzene ring. More preferably, R³ is 2,2-propylene. Examples of the second organic solvent include toluene, styrene, and hydroxyethyl methacrylate (HEMA).

Preferably, the surface-modifying polymer film 22 has a thickness ranging from 1 μm to 100 μm so as to sufficiently preserve the surface free energy of the plasma treated surface 212 and to achieve a shorter drying time when coated on the plasma treated surface 212.

Preferably, the substantially non-polar plastic material is ultra high molecular weight polyethylene (UHMWPE). Preferably, the ultra high molecular weight polyethylene has a weight average molecular weight ranging from 1,000,000 to 9,000,000.

The modified CTBN composition further contains a peroxide hardener for catalyzing polymerization of the modified CTBN composition for increasing the molecular weight of the modified CTBN. Examples of the peroxide hardener include benzoyl peroxide (BPO), dibenzoyl peroxide, lauroyl peroxide, and dilauroyl peroxide. The modified CTBN composition has a hardening time that depends on the concentration of the peroxide hardener in the modified CTBN composition. Hence, the hardening time of the modified CTBN composition can be controlled to be several minutes or several hours by adding different amounts of the peroxide hardener in the modified CTBN composition according to actual requirements.

The plasma treated surface 212 of the transparent polymer substrate 21 preferably has a water contact angle of less than 70 degrees, and more preferably less than 35 degrees. The smaller the water contact angle, the higher will be the surface free energy possessed by the plasma treated surface 212.

Formation of the polymer substrate 21 can be conducted by subjecting UHMWPE pellets to compression molding and cutting to form a preform, followed by activating a surface of the preform in a plasma chamber by plasma treatment using a hydrogen or oxygen gas as a reactive gas under a radio frequency ranging from 20 KHz to 13.56 MHz, an output power ranging from 1 Kw to 10 Kw, and a chamber pressure ranging from 0.001 bar to 1.0 bar. The water contact angle of the surface of the preform is greatly reduced after the plasma treatment, thereby increasing the surface free energy of the surface of the preform and forming the plasma treated surface 212 of the polymer substrate 21. However, the surface free energy of the plasma treated surface 212 can be quickly lost within hours when exposed to the atmosphere or during handling or transporting. Hence, the plasma treated surface 212 of the transparent polymer substrate 21 is required to be covered by the surface-modifying polymer film 22 as soon as the former is formed so as to prevent loss of the surface free energy of the plasma treated surface 212.

The surface-modified plastic sheet 2 can be easily and strongly bonded to another material, such as a metallic material, a ceramic material, an alloy, a plastic material, a woven or non-woven fabric, or cloth, through an adhesive.

FIG. 2 shows the second preferred embodiment of a flexible transparent surface-modified plastic sheet 2 of the present invention. In addition to the transparent polymer substrate 21 and the surface-modifying polymer film 22, the surface-modified plastic sheet 2 further includes an adhesive layer 26 bonded to the surface-modifying polymer film 22, and an ink pattern 25 printed on the surface-modifying polymer film 22. The surface-modifying polymer film 22 is disposed between the adhesive layer 25 and the polymer substrate 21. The adhesive layer 26 is coated on the ink pattern 25 and the surface-modifying polymer film 22.

Since the polymer substrate 21 and the surface-modifying polymer film 22 are transparent, the ink pattern 25 can be seen through the polymer substrate 21 and the surface-modifying polymer film 22.

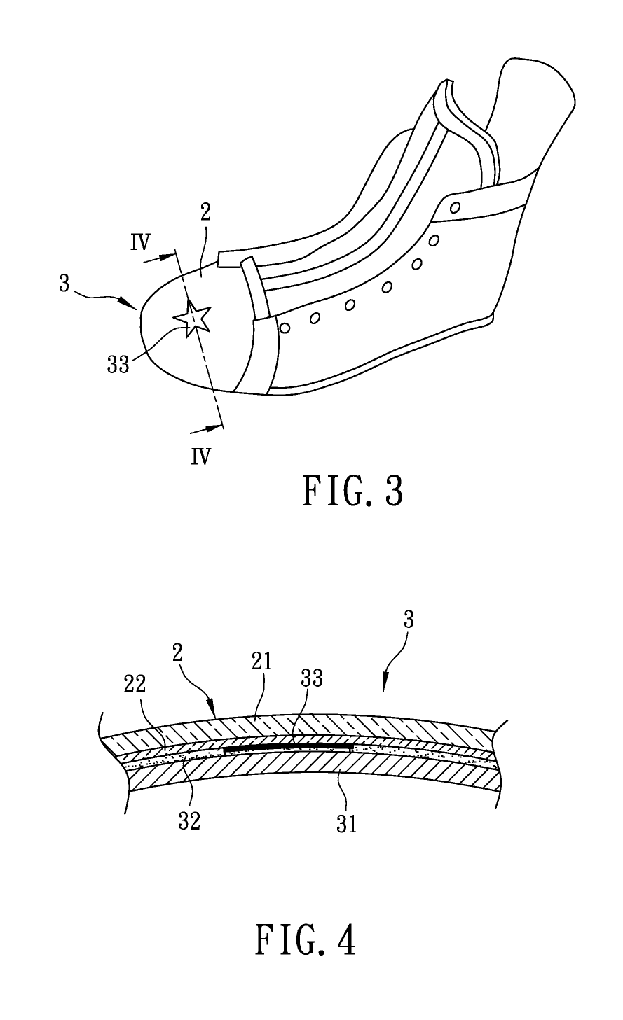

FIGS. 3 and 4 illustrate a structure of an article 3 (toecap) for footwear. The article includes: a main body 31 of a fabric; an adhesive layer 32; an ink pattern 33; and the surface-modified plastic sheet 2 of the first preferred embodiment that is bonded to the main body 31 through the adhesive layer 32. The ink pattern 33 is printed on the surface-modifying polymer film 22 of the surface-modified plastic sheet 2, and is disposed between the adhesive layer 32 and the surface-modifying polymer film 22. The surface-modified plastic sheet 2 serves as a skin layer (or a protective layer) of the article 3 (toecap), and exhibits enhanced impact strength, high resistance to extreme weather, high resistance to chemical corrosion, and high resistance to abrasion.

Since the surface-modified plastic sheet 2 is transparent, the ink pattern 33 can be seen through the surface-modified plastic sheet 2.

The following Examples are provided to illustrate the merits of the preferred embodiments of the invention, and should not be construed as limiting the scope of the invention.

### EXAMPLES

### Example 1 (E1)

A transparent polymer substrate made of UHMWPE was subjected to plasma treatment. A modified CTBN composition, containing 1 part by weight of BPO, 80 parts by weight of toluene and 20 parts by weight of the modified CTBN of formula (I) with R² represented by formula (II) and R³ being 2,2-propylene, was prepared, and was coated and completely dried under room temperature for about 5 minutes on the plasma treated polymer substrate so as to form a non-sticky transparent surface-modifying polymer film bonded to and cooperating with the transparent polymer substrate to form a surface-modified plastic sheet. An adhesion test medium of a carbon steel plate was subsequently bonded to the surface-modifying polymer film on the surface-modified plastic sheet through a modified CTBN adhesive (having the same composition as the previous modified CTBN) under pressing. The assembly of the carbon steel plate and the surface-modified plastic sheet was subjected to bonding strength test using an Instron test machine by peeling the surface-modified plastic sheet from the carbon steel plate. The measured bonding strength between the surface-modified plastic sheet and the carbon steel plate is 90.9 Kgf/cm.

### Example 2 (E2)

The procedures and conditions of preparing the surface-modified plastic sheet of Example 2 were the same as those of Example 1. The adhesion test medium was a stainless steel plate. The measured bonding strength between the surface-modified plastic sheet and the stainless steel plate is 121.7 Kgf/cm.

### Example 3 (E3)

The procedures and conditions of preparing the surface-modified plastic sheet of Example 3 were the same as those of Example 1. The adhesion test medium was a fiber-reinforce polymer (FRP) plate. The measured bonding strength between the surface-modified plastic sheet and the adhesion test medium is 74.1 Kgf/cm.

### Example 4 (E4)

The procedures and conditions of preparing the surface-modified plastic sheet of Example 4 were the same as those of Example 1. The adhesion test medium was a wood plate. The measured bonding strength between the surface-modified plastic sheet and the wood plate is 40.7 Kgf/cm.

### Example 5 (E5)

The procedures and conditions of preparing the surface-modified plastic sheet of Example 5 were similar to those of Example 1, except that the modified CTBN composition was replaced by a clear lacquer composition containing 30 wt % of poly(1,4-butylene adipate) and 70 wt % of cyclohexanone, and that the clear lacquer composition was coated and completely dried under room temperature for about 5 hours on the plasma treated polymer substrate. In addition, the surface-modified plastic sheet was bonded to the carbon steel plate through a polyurethane (PU) adhesive (catalog no.: 95NH, purchased from Great Eastern Resins Industrial Co., Taiwan). The measured bonding strength between the surface-modified plastic sheet and the carbon steel plate is 60 Kgf/cm.

### Example 6 (E6)

The procedures and conditions of preparing the surface-modified plastic sheet of Example 6 were the same as those of Example 5. The adhesion test medium was a stainless steel plate. The measured bonding strength between the surface-modified plastic sheet and the stainless steel plate is 70 Kgf/cm.

### Example 7 (E7)

The procedures and conditions of preparing the surface-modified plastic sheet of Example 7 were the same as those of Example 5. The adhesion test medium was a fiber-reinforced plastic (FRP) plate. The measured bonding strength between the surface-modified plastic sheet and the FRP plate is 60 Kgf/cm.

### Example 8 (E8)

The procedures and conditions of preparing the surface-modified plastic sheet of Example 8 were the same as those of Example 5. The adhesion test medium was a wood plate. The measured bonding strength between the surface-modified plastic sheet and the wood plate is 25 Kgf/cm.

The modified CTBN composition and the clear lacquer composition employed for forming the transparent surface-modifying polymer film 22 provide a considerable amount of polar functional groups on the surface-modifying polymer film 22, thereby enhancing adhesion of the transparent polymer substrate 21, and can be quickly dried in a few minutes or hours under room temperature, thereby overcoming the aforesaid drawbacks associated with the prior art. In addition, the modified CTBN composition and the clear lacquer composition are thermally resistant to extreme weather conditions (the modified CTBN composition can endure a temperature of up to 320° C. for 30 minutes without decomposition and the clear lacquer can endure a temperature of up to 200° C. for 5 minutes without decomposition). Furthermore, the modified CTBN composition and the clear lacquer composition permit the surface-modifying polymer film 22 to exhibit an excellent ink printability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A surface-modified plastic sheet comprising:
a transparent polymer substrate made from a substantially non-polar plastic material and having a plasma treated surface; and
a transparent surface-modifying polymer film coated on said plasma treated surface of said polymer substrate;
wherein said surface-modifying polymer film is made from a modified carboxy-terminated butadiene-acrylonitrile (CTBN) composition or a clear lacquer composition;
wherein said clear lacquer composition contains linear polyester polyol;
wherein said modified CTBN composition contains a modified CTBN that is represented by formula (I) 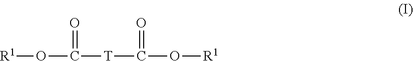
in which T is a butadiene-acrylonitrile copolymer and R¹ is represented by formula (II) 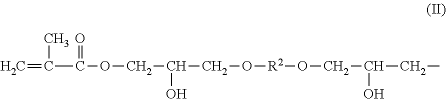
in which R² is a divalent hydrocarbyl group that contains at least one benzene ring.

2. The surface-modified plastic sheet of claim 1, wherein said substantially non-polar plastic material is ultra high molecular weight polyethylene.

3. The surface-modified plastic sheet of claim 1, wherein R² is represented by formula (III)
—Ar—R³—Ar— (III)
in which R³ is an alkylene group that has 1 to 4 carbon atoms and Ar is a divalent aromatic group having at least one benzene ring.

4. The surface-modified plastic sheet of claim 1, wherein said linear polyester polyol is poly(1,4-butylene adipate).

5. The surface-modified plastic sheet of claim 1, wherein said surface-modifying polymer film has a thickness ranging from 1 μm to 100 μm.

6. The surface-modified plastic sheet of claim 2, wherein said ultra high molecular weight polyethylene has a weight average molecular weight ranging from 1,000,000 to 9,000,000.

7. The surface-modified plastic sheet of claim 1, further comprising an adhesive layer bonded to said surface-modifying polymer film, said surface-modifying polymer film being disposed between said adhesive layer and said polymer substrate.

8. The surface-modified plastic sheet of claim 1, further comprising an ink pattern printed on said surface-modifying polymer film, and an adhesive layer coated on said ink pattern and said surface-modifying polymer film.

9. An article for footwear comprising:
a main body;
an adhesive layer; and
a surface-modified plastic sheet that is bonded to said main body through said adhesive layer and that includes
a transparent polymer substrate made from a substantially non-polar plastic material and having a plasma treated surface, and
a transparent surface-modifying polymer film coated on said plasma treated surface of said polymer substrate;
wherein said surface-modifying polymer film is made from a modified carboxy-terminated butadiene-acrylonitrile (CTBN) composition or a clear lacquer composition;
wherein said clear lacquer composition contains linear polyester polyol;
wherein said modified CTBN composition contains a modified CTBN that is represented by formula (I) 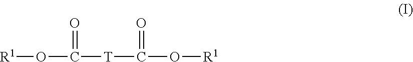
in which T is a butadiene-acrylonitrile copolymer and R¹ is represented by formula (II) 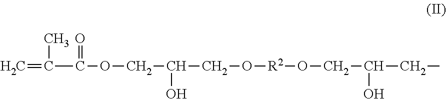
in which R² is a divalent hydrocarbyl group that contains at least one benzene ring.

10. The article of claim 9, further comprising an ink pattern printed on said surface-modifying polymer film and disposed between said adhesive layer and said surface-modifying polymer film.

11. The article of claim 9, wherein said substantially non-polar plastic material is ultra high molecular weight polyethylene.

12. The article of claim 9, wherein R² is represented by formula (III)
—Ar—R³—Ar— (III)
in which R³ is an alkylene group that has 1 to 4 carbon atoms and Ar is a divalent aromatic group having at least one benzene ring

13. The article of claim 9, wherein said linear polyester polyol is poly(1,4-butylene adipate).

14. The article of claim 9, wherein said surface-modifying polymer film has a thickness ranging from 1 μm to 100 μm.

15. The article of claim 11, wherein said ultra high molecular weight polyethylene has a weight average molecular weight ranging from 1,000,000 to 9,000,000.
